(19) United States
(12) Patent Application Publication
(10) Pub. No.: US 2017/0275986 A1
(43) Pub. Date: Sep. 28, 2017

(54) FLUID FLOW METERING WITH POINT SENSING

(71) Applicant: HALLIBURTON ENERGY SERVICES INC., Houston, TX (US)

(72) Inventors: Leonardo de Oliveira NUNES, Rio de Janeiro (BR); Christopher Lee STOKELY, Houston, TX (US); Jesse CHOE, Houston, TX (US)

(21) Appl. No.: 15/505,043

(22) PCT Filed: Nov. 5, 2015
(86) PCT No.: PCT/US2015/059169

§ 371 Date: Feb. 17, 2017

(51) Int. Cl. E21B 47/10; G01F 15/06; G01H 9/00; G01F 1/66

(52) U.S. Cl. CPC E21B 47/101; G01F 1/667; G01F 15/06; G01H 9/004; G01H 17/00

(57) ABSTRACT

Methods and systems are presented in this disclosure for fluid flow metering with point sensing. A transducer (acoustic sensor) located at a point externally along a pipe (e.g., deployed in a wellbore) can transform a mechanical energy of a fluid flow in the pipe into an acoustic signal, which is then acquired and digitized to obtain a digital signal. The acquired digital signal related to the fluid flow can be processed by applying various advance signal processing techniques in order to remove sharp and/or broadband resonances due to a turbulent fluid flow to determine energy associated with the fluid flow. A rate of the fluid flow can be then estimated by mapping the determined energy to a fluid flow rate.

### TECHNICAL FIELD

The present disclosure generally relates to measuring fluid flows in hydrocarbon wells and, more particularly, to fluid flow metering with point sensing.

### BACKGROUND

In the oil and gas industry, as in many other industries, ability to monitor and measure flow of certain fluids in conduits, tubulars, process pipes and the like, especially in real time, offers considerable value. Oil and gas well operators often need to measure water, oil, gas flow rates, or a combination of these, during production, transportation and processing, and at various locations, such as downhole, at the wellhead, in transport pipelines, and the like. The information about flow rates aids in improving well production, making decisions regarding processes to apply to a well, preventing flow problems, and generally determining the well's performance.

Certain techniques enable measuring flow rates by utilizing two point sensors on opposite sides of the pipe. However, the two point sensor measuring techniques can be only applied on pipes that are very flexible (e.g., rubber hoses), and do not operate accurately and efficiently on thick steel pipes. Certain other techniques enable measuring fluid flow rates by utilizing a single sensor attached to a pipe. The single sensor techniques can be applied to slug, two phase flow, and single phase flow. These conventional single sensor techniques can be also applied for measuring fluid flow rates that are very turbulent. However, the conventional single sensor techniques measure fluid flow rates by having a transducer (e.g., acoustic sensor) in direct contact with a fluid flowing through a pipe. This requires drilling a hole into the pipe to allow for a port for installation of the transducer having access to the fluid inside the pipe. In addition, the conventional single sensor techniques do not incorporate any substantial signal processing operations that may be required to mitigate sharp resonances and/or broadband resonances in acoustic signals related to turbulent fluid flows.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements.

FIG. 1 is a schematic diagram of a system for fluid flow measurements, according to certain embodiments of the present disclosure.

FIG. 2 is a block diagram of a signal processing method applied for fluid flow measurements, according to certain embodiments of the present disclosure.

FIG. 3 is a graph illustrating a mapping function between an output of the signal processing from FIG. 2 and a fluid flow rate estimate, according to certain embodiments of the present disclosure.

FIG. 4 is a flow chart of a method for fluid flow metering, according to certain embodiments of the present disclosure.

FIG. 5 is a block diagram of an illustrative computer system in which embodiments of the present disclosure may be implemented.

FIG. 6 is a diagram of a land-based drilling system in which the system for fluid flow measurements from FIG. 1 may be used, according to certain embodiments of the present disclosure.

### DETAILED DESCRIPTION

Embodiments of the present disclosure relate to fluid flow metering with point sensing. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one ordinarily skilled in the art to implement such feature, structure, or characteristic in connection with other embodiments whether or not explicitly described. It would also be apparent to one ordinarily skilled in the relevant art that the embodiments, as described herein, can be implemented in many different embodiments of software, hardware, firmware, and/or the entities illustrated in the Figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

The disclosure may repeat reference numerals and/or letters in the various examples or Figures. This repetition is for the purpose of simplicity and clarity and does not in itself dictate a relationship between the various embodiments and/or configurations discussed. Further, spatially relative terms, such as beneath, below, lower, above, upper, uphole, downhole, upstream, downstream, and the like, may be used herein for ease of description to describe one element or feature's relationship to another element(s) or feature(s) as illustrated, the upward direction being toward the top of the corresponding Figure and the downward direction being toward the bottom of the corresponding Figure, the uphole direction being toward the surface of the wellbore, the downhole direction being toward the toe of the wellbore. Unless otherwise stated, the spatially relative terms are intended to encompass different orientations of the apparatus in use or operation in addition to the orientation depicted in the Figures. For example, if an apparatus in the Figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Moreover even though a Figure may depict a horizontal wellbore or a vertical wellbore, unless indicated otherwise, it should be understood by those ordinarily skilled in the art that the apparatus according to the present disclosure is equally well suited for use in wellbores having other orientations including vertical wellbores, slanted wellbores, multilateral wellbores or the like. Likewise, unless otherwise noted, even though a Figure may depict an offshore operation, it should be understood by those ordinarily skilled in the art that the apparatus according to the present disclosure is equally well suited for use in onshore operations and vice-versa. Further, unless otherwise noted, even though a Figure may depict a cased hole, it should be understood by those ordinarily skilled in the art that the apparatus according to the present disclosure is equally well suited for use in open hole operations.

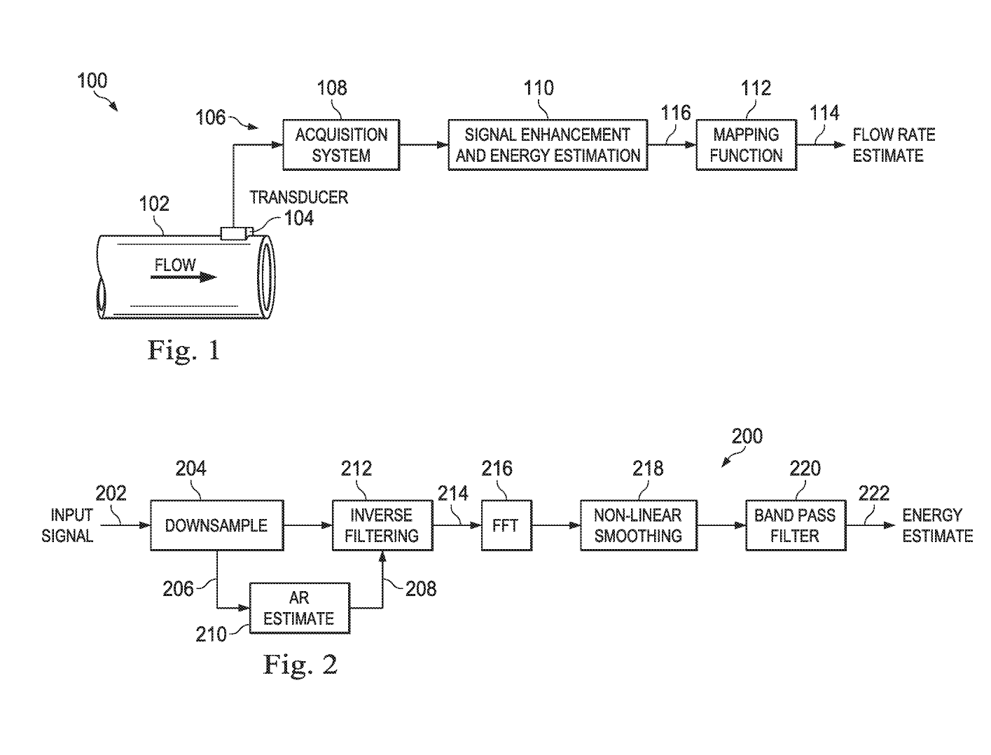

Illustrative embodiments and related methods of the present disclosure are described below in reference to FIGS. 1-6 as they might be employed for fluid flow metering with point sensing. Such embodiments and related methods may be practiced, for example, using a computer system as described herein. Other features and advantages of the disclosed embodiments will be or will become apparent to one of ordinary skill in the art upon examination of the following Figures and detailed description. It is intended that all such additional features and advantages be included within the scope of the disclosed embodiments. Further, the illustrated Figures are only illustrative and are not intended to assert or imply any limitation with regard to the environment, architecture, design, or process in which different embodiments may be implemented.

Certain embodiments of the present disclosure relate to a point flow meter for use in hydrocarbon wells that are producing large amounts of fluid (e.g., oil or gas). The method and system presented in this disclosure has the advantage of low cost, no moving parts, no restrictions to the wellbore, long term monitoring capability (e.g., without interventions), no downhole electrical components, and no requirement for electrical cabling from a surface to a downhole sensor. By placing multiple of the flow meters downhole, flow rates from individual oil well regions can be determined.

Certain embodiments of the present disclosure relate to measuring very turbulent fluid flow rates of a single and/or multiple phase fluid at one or more point locations along a steel pipe (or a pipe made of metal or very stiff material) using an acoustic sensor attached to the pipe (without direct contact with a fluid flowing through the pipe) and various methods for signal processing of an acoustic signal related to the fluid flow and acquired by the acoustic sensor. For some illustrative embodiments, a pipe may be located at least partially below ground or may be located at least partially above ground, e.g., a pipe may be deployed in a wellbore or may be a part of a transport pipeline. In one or more embodiments of the present disclosure, measurement location of the acoustic sensor can be outside of a pipe, for example, at a specific point along the pipe. The signal processing methods are developed, tested, and validated for the purpose of the present disclosure.

Embodiments of the present disclosure relate to a method for measuring fluid flow rates using point sensors. The method and apparatus presented herein may comprise three main parts: data acquisition by an acoustic sensor, signal enhancement and acoustic energy estimation, and flow estimation through mapping function. Each of these parts is described in greater detail in the present disclosure.

FIG. 1 is a schematic diagram 100 of a system for fluid flow measurements, according to certain illustrative embodiments of the present disclosure. In one or more embodiments, a fluid (e.g., a hydrocarbon such as oil or gas) may flow through a pipe 102 comprising one or more transducers (e.g., acoustic sensors) 104 located at certain pre-determined position(s) or point(s) along the pipe 102. In accordance with certain embodiments of the present disclosure, the pipe 102 may be deployed in a horizontal wellbore or in a vertical wellbore (not shown). For some illustrative embodiments, each transducer (e.g., acoustic sensor) 104 may be configured to transform mechanical energy of fluid flow at a particular point along the pipe 102 into acoustic vibrations. Processing system 106 illustrated in FIG. 1 that may be located outside the pipe 102 may comprise an acquisition system 108 configured to acquire the acoustic vibrations generated by the transducer 104 and to transform analog acoustic vibrations into a digital signal suitable for signal processing. As further illustrated in FIG. 1 and described in more detail below, the processing system 106 may also comprise signal enhancement and energy estimation (signal processing) block 110 and mapping function block 112 applied to obtain a fluid flow rate estimate 114.

Embodiments of the acoustic sensors employed in the present disclosure can be optical or mechanical. Optical embodiments can be, but are not limited to, fiber optic coils that utilize distributed acoustic sensing (DAS), fiber clamps for point sensing that utilize DAS, interferometers attached at a point location with partially reflecting mirrors embedded in a core of a fiber optic cable, fiber Bragg gratings, optical geophones, and the like. Other embodiments of the acoustic sensors employed in the present disclosure may comprise accelerometers, piezoelectric crystals or any mechanical device responsible for capturing acoustic vibrations. In one or more embodiments of the present disclosure, a signal from the transducer (e.g., acoustic sensor) 104 may be digitized by the acquisition system 108 to be processed by either a general purpose computer or a dedicated digital hardware by applying, as illustrated in FIG. 1, the signal enhancement and energy estimation 110 and mapping 112 in order to obtain fluid flow rate estimate 114.

For certain embodiments of the present disclosure, one or more signal processing techniques may be applied to an acoustic signal obtained by the acoustic sensor 104 and acquired and digitized by the acquisition system 108 in order to mitigate sharp resonances and/or broadband harmonics that may be created within the acoustic signal by a rigid pipe (e.g., the pipe 102 illustrated in FIG. 1) due to a turbulent fluid flow. These unwanted signal components may override the acoustic signal related to the turbulent fluid flow, and thus need to be removed from the acoustic signal. Embodiments of the present disclosure apply several signal processing operations illustrated in FIG. 2 in order to remove the unwanted signal contributions from the acoustic signal related to a fluid flow in a pipe.

FIG. 2 is a block diagram 200 of signal processing operations applied for fluid flow estimation and measurements, according to certain illustrative embodiments of the present disclosure. In one or more embodiments, the block diagram 200 may correspond to the signal enhancement and energy estimation block 110 illustrated in FIG. 1. Input signal 202 may comprise the acoustic signal from the acoustic sensor (transducer) 104 acquired by the acquisition system 108 (e.g., the digitized acoustic signal related to a fluid flow with unwanted signal components). As illustrated in FIG. 2, downsampling of the input signal 202 may be initially performed at block 204 in order to reduce a bandwidth of the acquired signal to the region between 0 and 1 kHz where fluid flow information is more predominant. In one or more embodiments, the signal downsampling is only required if the signal related to the fluid flow is acquired at sampling rates above 2 kHz.

For certain embodiments of the present disclosure, a low-order auto-regressive (AR) model may be then fit to a downsampled signal 206 in order to capture the pipe-induced resonances and to obtain AR estimates 208 observed in the digitized acquired signal 202. As illustrated in FIG. 2, the AR estimates 208 may be obtained at AR estimate block 210, wherein different algorithms may be employed at the AR estimate block 210, such as the Burg Method, the Yule-Walker method, and the like.

Once the AR model of the pipe resonances is known (e.g., the AR estimates 208 are obtained), the AR estimates 208 (e.g., pipe resonances) can be filtered out of the downsampled signal 206 through an inverse filter 212 that uses as coefficients inverse values of the AR model coefficients. In one or more embodiments, the inverse filter 212 can be implemented as a finite impulse response (FIR) filter whose coefficients may be computed from the AR model coefficients.

Once the resonance-free signal 214 is obtained at the output of the inverse filter 212, spectral components of the signal 214 may be computed through the Discrete Fourier Transform (DFT), which may be implemented through its computer-efficient version, the Fast Fourier Transform (FFT) 216. In one or more embodiments of the present disclosure, only the magnitude (absolute) value of the spectral components is of interest, and the phase information can be discarded.

While broad-band pipe-induced resonances (e.g., the AR estimates 208) have been removed from the digitized acquired acoustic signal 202, narrow-band components were not. In order to mitigate the influence of narrow-band components in the computed values, a non-linear filtering operation can be applied in the frequency domain, at block 218. The non-linear filtering operation applied at block 218 may comprise obtaining a smoothed estimate of the spectral content of a signal at the output of FFT block 216, which is immune to narrow-band components appearing as very narrow peaks in the magnitude spectrum of the signal.

Once the narrow-band components are removed from the signal spectrum by applying the non-linear smoothing at block 218, a signal at the output of the non-linear smoothing block 218 may be band-limited in the frequency domain by applying a band-pass filter 220 to further refine the region in which flow information is present. In one or more embodiments, regions of interest can be between 50 Hz and 800 Hz, but may vary by fluid type and other physical factors. Energy estimate 222 of the band-limited signal at the output of the band-pass filter 220 may be computed directly in the frequency-domain. For certain embodiments of the present disclosure, the signal processing operations illustrated in FIG. 2 can be applied to blocks of the acquired digitized acoustic signal 202, whose output represents a single estimate of the portion of its energy associated with a fluid flow in a pipe.

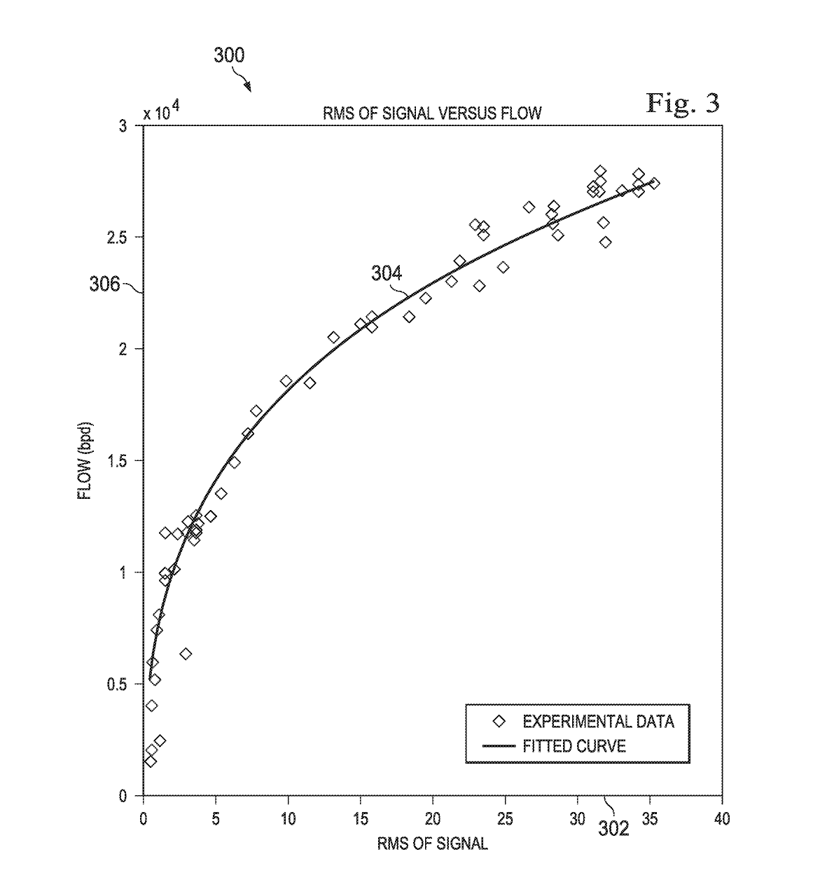

Once the energy estimate 222 of an acoustic signal associated with a fluid flow in a pipe is obtained, the next operation may comprise mapping the energy estimate 222 to a flow rate estimate. In one or more embodiments, a certain pre-determined mapping function (e.g., the mapping function 112 of processing system 106 illustrated in FIG. 1) may be applied to the energy estimate 222. FIG. 3 illustrates an example graph 300 of a mapping function (e.g., the mapping function 112 from FIG. 2) that may be applied to map the energy estimate 222 to a fluid flow rate, according to certain illustrative embodiments of the present disclosure. As illustrated in FIG. 3, root mean square (RMS) signal value 302 (e.g., energy estimate 116 in FIG. 1, energy estimate 222 in FIG. 2) may be mapped (e.g., by applying a fitted curve 304 obtained based on experimental data) to a fluid flow rate 306 (e.g., represented in units of barrels per day (BPD)). In one or more embodiments, the obtained fluid flow rate 306 may correspond to the fluid flow rate estimate 114 in FIG. 1. For certain embodiments, different mapping curves can be calibrated for different fluids and/or combination of fluids flowing through a pipe, and stored in a memory (e.g., as look-up tables). The system for flow metering presented in this disclosure may then employ the most appropriate mapping function.

Embodiments of the present disclosure may utilize only one acoustic point sensor and employ advanced signal processing operations to eliminate unwanted signal components from the acquired digital acoustic signal related to a fluid flow in a pipe (which may be deployed in a wellbore). The method and apparatus presented in this disclosure configured for fluid flow metering with point sensing can be applied to a wide variety of pipes, e.g., very flexible pipes and thick steel pipes. Embodiments of the present disclosure can be also applied to a single phase fluid flow and a two-phase fluid flow. In addition, embodiments of the present disclosure can be applied to measure very turbulent fluid flow rates since advanced signal processing operations are incorporated for removal of sharp resonances and/or broadband resonances from the acquired acoustic signal related to a fluid flow in a pipe.

Embodiments of the present disclosure may relate to downhole flow monitoring, which is a crucial aspect of the oil and gas industry especially in the fields of well production and completion. During well completion, downhole flow monitoring can allow for more efficient resource allocation and more accurate completions. During well production, flow monitoring can measure the output of the well. In one or more embodiments, multiphase downhole flow monitoring may allow for identification of high throughput areas and the composition (e.g., water, gas, oil, and the like) of the fluid flow. The acoustic based flow method and apparatus presented in this disclosure provide a means of non-invasively measuring fluid flow for long durations. Because the acoustic methods presented herein do not require the apparatus to be placed within the pipe and to directly interact with fluid flow, the approach presented in this disclosure also allows measuring fluid flow in different conditions such as hydraulic fracturing operations where traditional flow meters such as spinners would get severely damaged.

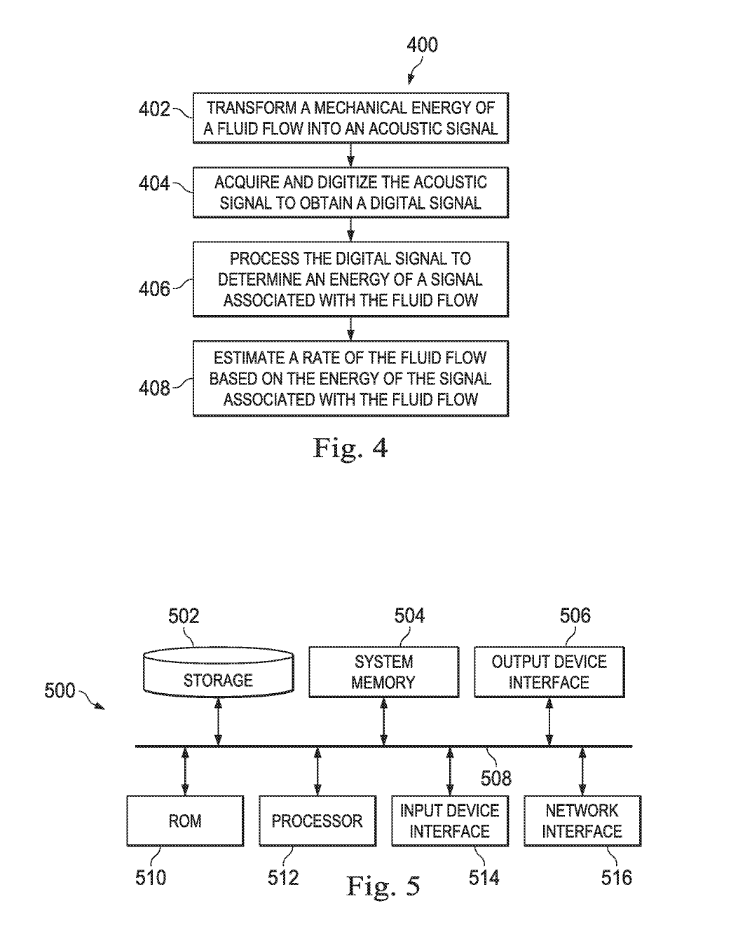

Discussion of an illustrative method of the present disclosure will now be made with reference to FIG. 4, which is a flow chart 400 of a method for fluid flow metering, according to certain illustrative embodiments of the present disclosure. The method begins at 402 by transforming (e.g., by the transducer 104 illustrated in FIG. 1) a mechanical energy of a fluid flow (e.g., fluid flow through the pipe 102 illustrated in FIG. 1) into an acoustic signal. At 404, the acoustic signal may be acquired and digitized (e.g., by the acquisition system 108) to obtain a digital signal. At 406, the digital signal may be processed (e.g., by signal enhancement and energy estimation block 110 illustrated in FIG. 1, by blocks 204, 210, 212, 216, 218 and 220 illustrated in FIG. 2) to determine an energy of a signal associated with the fluid flow. At 408, a rate of the fluid flow may be estimated (e.g., by mapping function 112 illustrated in FIG. 1) based on the energy of the signal associated with the fluid flow.

FIG. 5 is a block diagram of an illustrative computing system 500 in which embodiments of the present disclosure may be implemented adapted for flow metering with point sensing. For example, some of the operations of method 400 of FIG. 4, as described above, may be implemented using the computing system 500. The computing system 500 can be a computer, phone, personal digital assistant (PDA), or any other type of electronic device. Such an electronic device includes various types of computer readable media and interfaces for various other types of computer readable media. In one or more embodiments, the computing system 500 may comprise the processing system 106 illustrated in FIG. 1. Furthermore, the signal enhancement and energy estimation block 110 in FIG. 1, as well as the signal processing blocks 204, 210, 212, 216, 218 and 220 illustrated in FIG. 2 may be an integral part of the computing system 500.

As shown in FIG. 5, the computing system 500 includes a permanent storage device 502, a system memory 504, an output device interface 506, a system communications bus 508, a read-only memory (ROM) 510, processing unit(s) 512, an input device interface 514, and a network interface 516.

The bus 508 collectively represents all system, peripheral, and chipset buses that communicatively connect the numerous internal devices of the computing system 500. For instance, the bus 508 communicatively connects the processing unit(s) 512 with the ROM 510, the system memory 504, and the permanent storage device 502.

From these various memory units, the processing unit(s) 512 retrieves instructions to execute and data to process in order to execute the processes of the subject disclosure. The processing unit(s) can be a single processor or a multi-core processor in different implementations.

The ROM 510 stores static data and instructions that are needed by the processing unit(s) 512 and other modules of the computing system 500. The permanent storage device 502, on the other hand, is a read-and-write memory device. This device is a non-volatile memory unit that stores instructions and data even when the computing system 500 is off. Some implementations of the subject disclosure use a mass-storage device (such as a magnetic or optical disk and its corresponding disk drive) as the permanent storage device 502.

Other implementations use a removable storage device (such as a floppy disk, flash drive, and its corresponding disk drive) as the permanent storage device 502. Like the permanent storage device 502, the system memory 504 is a read-and-write memory device. However, unlike the storage device 502, the system memory 504 is a volatile read-and-write memory, such a random access memory. The system memory 504 stores some of the instructions and data that the processor needs at runtime. In some implementations, the processes of the subject disclosure are stored in the system memory 504, the permanent storage device 502, and/or the ROM 510. For example, the various memory units include instructions for computer aided pipe string design based on existing string designs in accordance with some implementations. From these various memory units, the processing unit(s) 512 retrieves instructions to execute and data to process in order to execute the processes of some implementations.

The bus 508 also connects to the input and output device interfaces 514 and 506. The input device interface 514 enables the user to communicate information and select commands to the computing system 500. Input devices used with the input device interface 514 include, for example, alphanumeric, QWERTY, or T9 keyboards, microphones, and pointing devices (also called “cursor control devices”). The output device interfaces 506 enables, for example, the display of images generated by the computing system 500. Output devices used with the output device interface 506 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 5, the bus 508 also couples the computing system 500 to a public or private network (not shown) or combination of networks through a network interface 516. Such a network may include, for example, a local area network (“LAN”), such as an Intranet, or a wide area network (“WAN”), such as the Internet. Any or all components of the computing system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, the operations of method 400 of FIG. 4, as described above, may be implemented using the computing system 500 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs implemented on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of operations in the processes disclosed is an illustration of exemplary approaches. Based upon design preferences, it is understood that the specific order or hierarchy of operations in the processes may be rearranged, or that all illustrated operations be performed. Some of the operations may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the illustrative methods described herein may be implemented by a system including processing circuitry or a computer program product including instructions which, when executed by at least one processor, causes the processor to perform any of the methods described herein.

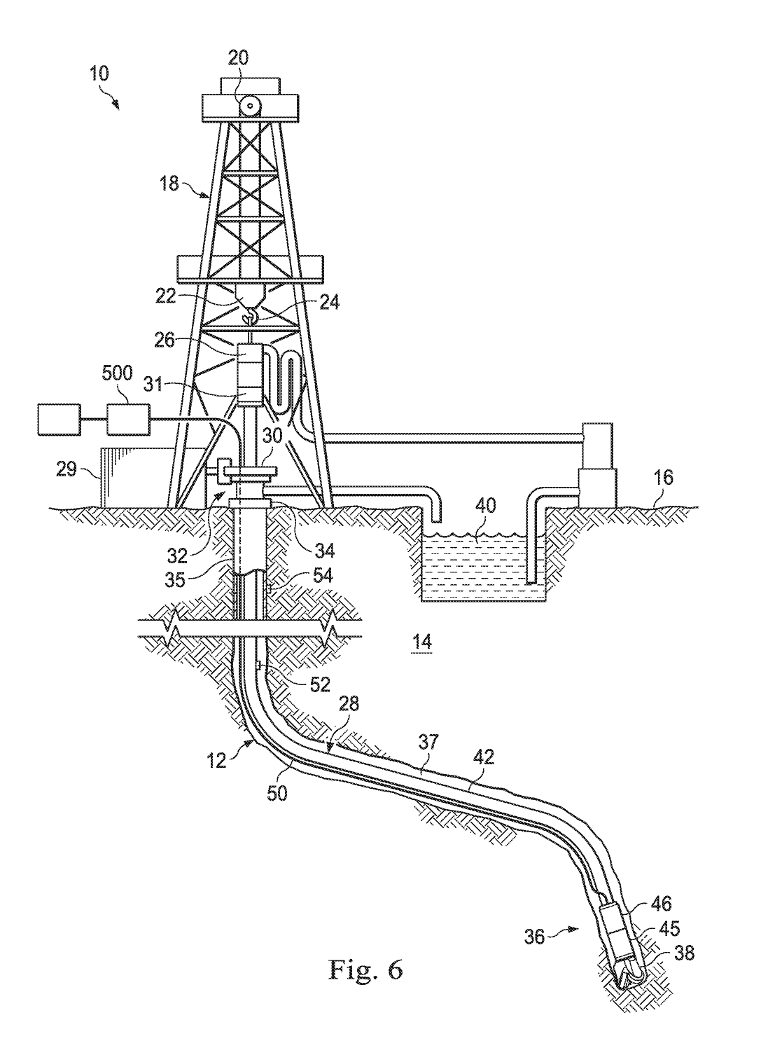

FIG. 6 is an elevation view in partial cross-section of a drilling and production system 10 utilized to recover hydrocarbons from a wellbore 12 extending through various earth strata in an oil and gas formation 14 located below the earth's surface 16. Drilling and production system 10 may include a drilling rig 18, such as the land drilling rig shown in FIG. 6. Drilling rig 18 may include a hoisting apparatus 20, a travel block 22, a hook 24 and a swivel 26 or similar mechanisms for raising and lowering various conveyance vehicles 28, such as pipe string, coiled tubing, wireline, slickline, and the like. In the illustration, conveyance vehicle 28 is a substantially tubular, axially extending drill string. Likewise, drilling rig 12 may include rotary table 30, rotary drive motor 29, and other equipment associated with rotation and/or translation of tubing string 28 within a wellbore 12. For some applications, drilling rig 18 may also include a top drive unit 31. Although drilling system 10 is illustrated as being a land-based system, drilling system 10 may be deployed on offshore platforms, semi-submersibles, drill ships, and the like.

Drilling rig 18 may be located proximate to or spaced apart from a well head 32, such as in the case of an offshore arrangement (not shown). One or more pressure control devices 34, such as blowout preventers and other equipment associated with drilling or producing a wellbore may also be provided at well head 32.

Wellbore 12 may include a casing string 35 cemented therein. Annulus 37 is formed between the exterior of tubing string 28 and the inside wall of wellbore 12 or casing string 35, as the case may be.

The lower end of drill string 28 may include bottom hole assembly 36, which may carry at a distal end a rotary drill bit 38. Drilling fluid 40 may be pumped to the upper end of drill string 28 and flow through the longitudinal interior 42 of drill string 28, through bottom hole assembly 36, and exit from nozzles formed in rotary drill bit 38. At bottom end 44 of wellbore 12, drilling fluid 40 may mix with formation cuttings, formation fluids and other downhole fluids and debris. The drilling fluid mixture may then flow upwardly through annulus 37 to return formation cuttings and other downhole debris to the surface 16.

Bottom hole assembly 36 may include a downhole mud motor 45. Bottom hole assembly 36 and/or drill string 28 may also include various other tools 46 including Measurement While Drilling (MWD) tools, Logging While Drilling (LWD) instruments, detectors, circuits, or other equipment that provide information about wellbore 12 and/or formation 14, such as logging or measurement data from wellbore 12. Measurement data and other information may be communicated using electrical signals, acoustic signals or other telemetry that can be converted to electrical signals at the well surface to, among other things, monitor the performance of drilling string 28, bottom hole assembly 36, and associated rotary drill bit 32, as well as monitor the conditions of the environment to which the bottom hole assembly 36 is subjected.

Shown deployed in association with drilling and production system 10 is an acoustic sensor 52 located at a point location on drill string (pipe) 28. In one or more embodiments, acoustic sensor 52 may correspond to the transducer 104 of the system for fluid flow measurements 100 illustrated in FIG. 1. Acoustic sensor 52 attached at the exterior of drill string 28 may be configured to convert mechanical energy related to a flow of drilling fluid 40 through drill string 28 into an acoustic signal (vibrations). The generated acoustic vibrations are further processed as described in the present disclosure to obtain an estimate of drilling fluid flow rate.

Shown also deployed in association with drilling and production system 10 is an acoustic sensor 54 located at a point location on casing string 35. In one or more embodiments, acoustic sensor 54 may correspond to the transducer 104 of the system for fluid flow measurements 100 illustrated in FIG. 1. For certain embodiments, acoustic sensor 54 attached at the exterior of casing string 35 may be configured to convert mechanical energy related to a flow of production fluid (e.g., hydrocarbon, such as oil or gas) or through casing string 35 into an acoustic signal (vibrations). The generated acoustic vibrations are further processed as described in the present disclosure to obtain an estimate of production fluid flow rate. For certain other embodiments, acoustic sensor 54 attached at the exterior of casing string 35 may be configured to convert mechanical energy related to a flow of fluid(s) or mixture of fluids (e.g., drilling mud, spacer fluid, cement) flowing along casing string 35 in annulus 37 during wellbore completion operation into an acoustic signal (vibrations). The generated acoustic vibrations are further processed as described in the present disclosure to obtain an estimate of flow rate of one or more fluids flowing through annulus 37 during wellbore completion operation.

Shown further deployed in association with drilling and production system 10 is computer system 500 illustrated in FIG. 5 adapted for estimating fluid flow rates as described herein. For example, during a drilling procedure, acoustic sensor 52 attached at the exterior of drill string 28 may generate an acoustic signal (vibrations) related to the flow of drilling fluid 40. The generated acoustic signal may be communicated (e.g., via wireline connection or wirelessly) to computer system 500 for signal acquisition, digitizing, and signal processing (e.g., enhancement and energy estimation). For some embodiments, as described above, computer system 500 may comprise processing system 106 illustrated in FIG. 1 and/or system 200 illustrated in FIG. 2. The permanent storage device 502, and/or the ROM 510 of computer system 500 may comprise one or more mapping functions (e.g., stored as look-up tables) for mapping estimated signal energy into a drilling fluid flow rate.

Further, during completion and/or production operations, acoustic sensor 54 attached at the exterior of casing string 35 may generate an acoustic signal (vibrations) related to the flow of production fluid or the flow of annulus fluid(s). The generated acoustic signal may be communicated (e.g., via wireline connection or wirelessly) to computer system 500 for signal acquisition, digitizing, and signal processing (e.g., enhancement and energy estimation). The permanent storage device 502, and/or the ROM 510 of computer system 500 may comprise one or more mapping functions (e.g., stored as look-up tables) for mapping estimated signal energy into a production fluid flow rate or an annulus fluid flow rate.

A method for fluid flow metering with point sensing has been described and may generally include: transforming a mechanical energy of a fluid flow into an acoustic signal; acquiring and digitizing the acoustic signal to obtain a digital signal; processing the digital signal to determine an energy of a signal associated with the fluid flow; and estimating a rate of the fluid flow based on the energy of the signal associated with the fluid flow.

For the foregoing embodiments, the method may include any one of the following operations, alone or in combination with each other: Processing the digital signal comprises removing resonances related to the fluid flow; Downsampling the digital signal to obtain a downsampled signal; Estimating an auto-regressive (AR) model of resonances associated with the downsampled signal; Filtering the resonances out from the downsampled signal using the AR model to obtain a filtered signal; Computing a spectral content of the filtered signal; Perform non-linear smoothing of the spectral content of the filtered signal to obtain a smoothed estimate of the spectral content; Performing band-pass filtering of the smoothed estimate of the spectral content to obtain a band-limited signal; Computing an energy of the band-limited signal; Estimating the AR model based on the Burg method or the Yule-Walker method; Filtering the resonances out from the downsampled signal by applying a filter that uses as coefficients inverse values of coefficients of the AR model; Computing the spectral content of the filtered signal by performing FFT of the filtered signal; Estimating the rate of the fluid flow by mapping, using a mapping function, the energy of the signal associated with the fluid flow to the rate of the fluid flow; Calibrating the mapping function based on a fluid for which the rate is estimated; Adjusting well production based on the estimated rate of the fluid flow; Performing well completion based on the estimated rate of the fluid flow.

Likewise, a system for flow metering has been described and includes: a transducer configured to transform a mechanical energy of a fluid flow into an acoustic signal; an acquisition circuit configured to acquire and digitize the acoustic signal to obtain a digital signal; at least one processor; and a memory coupled to the processor having instructions stored therein, which when executed by the processor, cause the processor to perform functions, including functions to: process the digital signal to determine an energy of a signal associated with the fluid flow; and estimate a rate of the fluid flow based on the energy of the signal associated with the fluid flow.

For any of the foregoing embodiments, the system may include any one of the following elements, alone or in combination with each other: the transducer comprises an acoustic sensor located externally along a pipe through which the fluid flows; the pipe is located at least partially above ground; the pipe is located at least partially below ground; the pipe is deployed in a wellbore; the acoustic sensor comprises: fiber optic coils that utilize DAS, fiber clamps that utilize DAS, fiber Bragg gratings, or optical geophones; the acoustic sensor comprises: an accelerometer, a piezoelectric crystal, or a mechanical device configured to capture vibrations related to the fluid flow; the fluid flow comprises a single phase fluid flow or a multiphase fluid flow; the functions to process the digital signal performed by the processor include functions to remove resonances related to the fluid flow; the functions to process the digital signal performed by the processor include functions to: downsample the digital signal to obtain a downsampled signal, estimate an AR model of resonances associated with the downsampled signal, filter the resonances out from the downsampled signal using the AR model to obtain a filtered signal, compute a spectral content of the filtered signal, perform non-linear smoothing of the spectral content of the filtered signal to obtain a smoothed estimate of the spectral content, perform band-pass filtering of the smoothed estimate of the spectral content to obtain a band-limited signal, and compute an energy of the band-limited signal; a bandwidth of the downsampled signal is smaller than or equal to 1 kHz; the AR model is estimated based on the Burg method or the Yule-Walker method; the functions to filter the resonances out from the downsampled signal performed by the processor include functions to apply a filter that uses as coefficients inverse values of coefficients of the AR model; the functions to compute the spectral content of the filtered signal performed by the processor include functions to perform FFT of the filtered signal; the functions to estimate the rate of the fluid flow performed by the processor include functions to map, using a mapping function, the energy of the signal associated with the fluid flow to the rate of the fluid flow; the functions performed by the processor include functions to: calibrate the mapping function based on a fluid for which the rate is estimated, and store the calibrated mapping function in the memory; the functions performed by the processor include functions to adjust well production based on the estimated rate of the fluid flow; the functions performed by the processor include functions to perform well completion based on the estimated rate of the fluid flow.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

While specific details about the above embodiments have been described, the above hardware and software descriptions are intended merely as example embodiments and are not intended to limit the structure or implementation of the disclosed embodiments. For instance, although many other internal components of computer system 500 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the Figures illustrate the architecture, functionality, and operation of possible implementations of systems, methods and computer program products according to various embodiments of the present disclosure. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

What is claimed is:

1. A system for fluid flow metering, the system comprising:
a transducer configured to transform a mechanical energy of a fluid flow into an acoustic signal;
an acquisition circuit configured to acquire and digitize the acoustic signal to obtain a digital signal;
at least one processor; and
a memory coupled to the processor having instructions stored therein, which when executed by the processor, cause the processor to perform functions, including functions to:
process the digital signal to determine an energy of a signal associated with the fluid flow; and
estimate a rate of the fluid flow based on the energy of the signal associated with the fluid flow.

2. The system of claim 1, wherein the transducer comprises an acoustic sensor located externally along a pipe through which the fluid flows.

3. The system of claim 2, wherein the pipe is located at least partially above ground.

4. The system of claim 2, wherein the pipe is located at least partially below ground.

5. The system of claim 4, wherein the pipe is deployed in a wellbore

6. The system of claim 2, wherein the acoustic sensor comprises: fiber optic coils that utilize distributed acoustic sensing (DAS), fiber clamps that utilize DAS, fiber Bragg gratings, or optical geophones.

7. The system of claim 2, wherein the acoustic sensor comprises: an accelerometer, a piezoelectric crystal, or a mechanical device configured to capture vibrations related to the fluid flow.

8. The system of claim 1, wherein the fluid flow comprises a single phase fluid flow or a multiphase fluid flow.

9. The system of claim 1, wherein the functions to process the digital signal performed by the processor include functions to remove resonances related to the fluid flow.

10. The system of claim 1, wherein the functions to process the digital signal performed by the processor include functions to:
downsample the digital signal to obtain a downsampled signal;
estimate an auto-regressive (AR) model of resonances associated with the downsampled signal;
filter the resonances out from the downsampled signal using the AR model to obtain a filtered signal;
compute a spectral content of the filtered signal;
perform non-linear smoothing of the spectral content of the filtered signal to obtain a smoothed estimate of the spectral content;
perform band-pass filtering of the smoothed estimate of the spectral content to obtain a band-limited signal; and
compute an energy of the band-limited signal.

11. The system of claim 10, wherein the functions to filter the resonances out from the downsampled signal performed by the processor include functions to apply a filter that uses as coefficients inverse values of coefficients of the AR model.

12. The system of claim 1, wherein the functions to estimate the rate of the fluid flow performed by the processor include functions to map, using a mapping function, the energy of the signal associated with the fluid flow to the rate of the fluid flow.

13. The system of claim 12, wherein the functions performed by the processor include functions to:
calibrate the mapping function based on a fluid for which the rate is estimated; and
store the calibrated mapping function in the memory.

14. The system of claim 1, wherein the functions performed by the processor include functions to adjust well production based on the estimated rate of the fluid flow.

15. The system of claim 1, wherein the functions performed by the processor include functions to perform well completion based on the estimated rate of the fluid flow.

16. A method for fluid flow metering, the method comprising:
transforming a mechanical energy of a fluid flow into an acoustic signal;
acquiring and digitizing the acoustic signal to obtain a digital signal;
processing the digital signal to determine an energy of a signal associated with the fluid flow; and
estimating a rate of the fluid flow based on the energy of the signal associated with the fluid flow.

17. The method of claim 16, wherein processing the digital signal comprises removing resonances related to the fluid flow.

18. The method of claim 16, wherein processing the digital signal comprises:
downsampling the digital signal to obtain a downsampled signal;
estimating an auto-regressive (AR) model of resonances associated with the downsampled signal;
filtering the resonances out from the downsampled signal using the AR model to obtain a filtered signal;
computing a spectral content of the filtered signal;
perform non-linear smoothing of the spectral content of the filtered signal to obtain a smoothed estimate of the spectral content;
performing band-pass filtering of the smoothed estimate of the spectral content to obtain a band-limited signal; and
computing an energy of the band-limited signal.

19. The method of claim 18, further comprising estimating the AR model based on the Burg method or the Yule-Walker method.

20. The method of claim 18, further comprising filtering the resonances out from the downsampled signal by applying a filter that uses as coefficients inverse values of coefficients of the AR model.

21. The method of claim 16, further comprising estimating the rate of the fluid flow by mapping, using a mapping function, the energy of the signal associated with the fluid flow to the rate of the fluid flow.

22. The method of claim 21, further comprising calibrating the mapping function based on a fluid for which the rate is estimated.

23. The method of claim 16, further comprising adjusting well production based on the estimated rate of the fluid flow.

24. The method of claim 16, further comprising performing well completion based on the estimated rate of the fluid flow.
